(19) United States
(12) Patent Application Publication
(10) Pub. No.: US 2007/0078192 A1
(43) Pub. Date: Apr. 5, 2007

(54) Mixture of beads and foam particles for use in soft furniture, pillows and other items

(76) Inventor: Robert Paul Leonardi, Austin, TX (US)

Correspondence Address: Wilson Daniel Swayze, Jr, 3804 Clearwater Ct., Plano, TX, 75025, US

(21) Appl. No.: 11/242,327

(22) Filed: Oct. 3, 2005

(51) Int. Cl. C08J 9/00

(52) U.S. Cl. 521/99

(57) ABSTRACT

A fill for soft furniture includes a first type of particle for filling the soft furniture and a second type of particle for filling the soft furniture, and the first type of particle is mixed with the second type of particle.

### PRIORITY

The present invention claims priority based on a provisional application having a Ser. No. 11/______ filed on Oct. 1, 2004.

### FIELD OF THE INVENTION

The present invention relates in general to a mixture of beads and foam particles that can be used in frameless or soft furniture including pillows which are known to some people as soft articles.

### BACKGROUND

Soft or frameless furniture including frameless chairs has been known in the art for several years. Furthermore, frameless chairs filled only with beads of polystyrene or only with foam have been likewise known in the art. One frameless chair is described in U.S. Pat. No. 6,725,482 and in U.S. Pat. No. 6,732,391, both are hereby incorporated by reference in their entirety.

While such conventional beanbag furniture has become popular, the shape-ability among other things of this beanbag furniture remains problematic. More particularly, after a conventional beanbag chair has been occupied by a person, the EPS beads that are held within the liner of the beanbag furniture remained substantially compressed, resulting in a depression where the person was sitting. This depression remains in the chair unless and until a person reshapes the chair by exerting a physical force upon it such as rolling, shaking, or fluffing the beanbag furniture.

An additional problem of beanbag furniture that is filled with beads is that the beads can be hard, and consequently, their use after a short amount of time may result in the occupant feeling uncomfortable as a result of the hard beads.

In addition to this the soft furniture filled with beads can be quite noisy with even the smallest movement.

In addition to this the soft furniture filled with beads compress quickly over time and the soft furniture, in industry parlance becomes “flat” after just a few months of use requiring the soft furniture to be refilled with bead fill or the soft furniture is in effect unusable.

Some solutions to these problem are offered in the above-mentioned patents. These patents disclose that commercially available polyurethane foam pieces are used to replace conventional inexpensive polystyrene beads because the polystyrene beads are not resiliently compressible. As a consequence, the polystyrene beads do not have any inherent ability to fill out an inner liner of the chair back to its original shape after the occupant departs from the chair. These patents go on to disclose that certain species of polyurethane foam are both compressible and resilient, and it has been found that polyurethane having a density between 1.0 and 4.0 pounds per square foot has a sufficient compressed ability to conform to the occupants bodily dimensions and is sufficiently resilient to fill out the chair once that the occupant has departed.

The soft furniture which is completely filled with polyurethane foam pieces has additional problems such as the foam pieces do not give a fluid feel and the beanbag furniture which is completely filled with polystyrene beads does have the fluid feel. The fluid feel is the ability of the beads to move with respect to each other and thereby conform to a predetermined or given shape.

The beads of beanbag and soft furniture are sometimes formed from EPS which is an abbreviation for expanded polystyrene. In its raw manufactured state, EPS that will be expanded into beads resemble very small pellets. The material in this state should be expanded with steam to activate the expanding agent. Various densities and sizes of the raw EPS, EPP pellets can be obtained and various densities and sizes of the beads can thereby be achieved by adjusting the time of exposure to steam. After the expanding agent has been vaporized and the beads have been hardened, the expanded beads may be passed through that process again to enlarge the beads one more time into longer shapes somewhat resembling a bean. In this state it is called double pass. The beads or beans as many consumers call them are transported to a large storage hoppers where the beads are allowed to age for a period of time prior to the use of the beads in production. When the beads have stabilized, the beads are transported. Other patents include U.S. Pat. Nos. 3,965,506 and 4,027,888

### SUMMARY

The present invention provides a solution to the above-mentioned problems and provides a fluid feel to soft furniture which is found to be desirable from the pure bean filled, soft furniture. Additionally, the soft furniture which incorporates the teachings of the present invention has the additional advantage of providing soft furniture that is generally soft to the touch and eliminates the hard feel of the pure bean filled, soft furniture.

Additionally, the soft furniture which incorporates the teachings of the present invention has the additional advantage of providing soft furniture that will not go “flat” like the pure bead filled, soft furniture.

In order to achieve these advantages with soft furniture, the soft furniture is filled with a mixture of these two ingredients, namely foam and beads. The beads referred to particles formed from EPS such that the beads are relatively stiff, while foam refers to particles that are less rigid and more resilient material with respect to the beads. The foam may be a shredded polyurethane foam or another suitable material in which the foam particles typically do not move with respect to each other while the foam is in contact with each other. The foam typically is not of uniform size, but may be of uniform size. The foam and the beads are intermixed in the soft furniture that tends to remain intermixed avoiding bunching of concentration of either the beads or the foam.

The beads may be either virgin beads or regrind (recycled) beads.

A mixture which is described in more detail below can be used in any type of soft furniture and other types of applications. For example, the mixture may be useful in pillows, pet beds, cushions of all types, ottomans, futons and any other suitable material.

It use of the material includes soft furniture that is washable or pool safe in that the foam employed is waterproof or water resistant.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a mixture in accordance with the teachings of the present invention.

FIG. 2 illustrates a schematic representation of an outer liner of the soft furniture.

### BRIEF DESCRIPTION

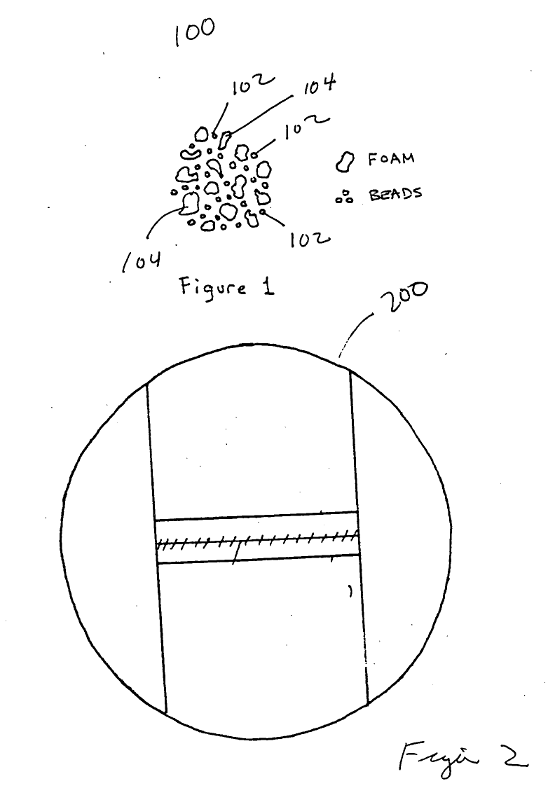

FIG. 1 illustrates a mixture 100 of beads 102 and foam 104 in which the beads 102 may be referred to as first type of particles such as EPS beads which are relatively stiff yet compressible for example the approximate common densities of expanded EPS are 0.9 to 2.4 lbs/ft³. The beads can move relatively freely with respect to each other so that the beads 102 in the soft furniture 200 can move within the soft furniture 200 so that the soft furniture 200 retains any displacement such as from a user sitting on the soft furniture 200 which may be frameless. The foam 104 refers to a second type of particles which are much less rigid and more resilient than the beads 102 and could be formed from shredded polyurethane foam. In contrast to the beads 102, the foam 104 typically does not move as easily within the soft furniture 200. Typically, the beads 102 maintain the same relative position with respect to the foam 104 when mixed with the foam 104.

With respect to the foam 104, FIG. 1 illustrates that the foam 104 is of different size with respect to each other or alternatively could be substantially the same size.

The mixture of beads 102 and foam 104 is both fluid in that it holds the shape in which it has been placed and consequently tends to mold to the body shape when you sit on the soft furniture and does not tend to flatten out.

The beads 102 could generally be characterized as either a virgin bead or a regrind (recycled) bead. The virgin beads are beads that have not been previously used for other purposes. Virgin beads when used in soft furniture 200 are fluid in that these virgin beads do not hold their shape as well as regrind beads and tend to move around easily. Consequently, the soft furniture 200 has additional amounts of give and can be easily molded to the shape of the body of the person sitting in the soft furniture 200. However, if it is necessary for the user of the soft furniture 200 to press against the soft furniture 200, it may be difficult to obtain sufficient resistance from the soft furniture 200 to obtain the support required when only virgin beads are used.

The regrind beads are expanded polystyrene pellets that have already been used for another purpose. Then, these used pellets are ground up to form the regrind beads. The regrind beads are generally less fluid than the virgin beads. Consequently, the regrind beads can move around less easily within the soft furniture 200. While getting more support, the soft furniture 200 with regrind beads may feel harder then soft furniture 200 which is filled with the virgin beads. The regrind beads may vary in the degree of coarseness. A coarser regrind bean may move around less than a non-coarse regrind bean in the soft furniture 200 but would have a harder feel that the non-course regrind bean.

The present invention employs a mixture of shredded foam and beads instead of only shredded foam or only EPS beards. The addition of EPS beads to the shredded foam gives the soft furniture 200 more body, more fluidity than using only foam for the soft furniture 200. As a consequence, the soft furniture 200 which is filled with a mixture of shredded foam and EPS beads is more easily molded to the occupant.

Alternatively, adding shredded foam to only EPS beads provides a mixture for the soft furniture 200 that is softer than using EPS beads alone, and as a result, the soft furniture 200 is more comfortable than the furniture filled with EPS beads alone. The soft furniture 200 filled with the mixture of shredded foam and EPS beads is generally easier for the occupant of the furniture to get out of the furniture than if the furniture is filled with virgin EPS beads.

While the above discussion has focused on the mixture being used in soft furniture 200, the mixture may be useful in pillows, pet beds, cushions, ottomans, futons or any other such type of furniture.

While the above discussion has been with a mixture of virgin EPS beads and shredded polyurethane foam, other mixtures for the soft furniture 200 may be used, for instance, regrind EPS beads may be used. Other beads may be formed from other material other than expanded polystyrene, and the foam may be formed from other materials other than polyurethane. Additionally, the beads may have other cross sectional areas, shapes, and sizes than shown and may be manufactured by other processes other than expansion used to form the EPS beads, In a similar fashion, the foam particles may have various shapes and sizes and may be manufactured by using various processes other than shredded polyurethane pieces of foam.

Other types of beads may include single-pass, double-pass, triple-pass and n-pass polyethylene and other types of foam may include polyethylene, polyurethane, open cell, closed cell, ‘dry fast’.

One alternative uses a mixture of 50% beads and 50% shredded foam. The beads may be double-pass, expanded, polystyrene. The average diameter of the beads is approximately 0.4 inches. The foam may be shredded polyurethane with the shredded foam particles having an approximately size between 0.25 and 5 inches in diameter.

Another alternative uses a mixture of two types of EPS beads including approximately one third of single pass beads and two thirds of double-pass beads with polyurethane foam having a density between approximately 1.0 and approximately 5.0 pounds per cubic foot. The mixture could be used to fill an inner liner of soft furniture.

The density of the polyurethane foam and the expanded polystyrene beads range from between approximately 1.3 and 4.8 approximately pounds per foot.

The present invention includes washable or pool safe soft furniture, pillows, cushions, pet beds or other items that could conform to the shape of a person or thing which comes in contact with the above described items. Under these circumstances, the mixture may include waterproof or water resistant foam and beads in accordance with the teachings of the present invention.

Another type of foam that could be used is an open cell foam that is available for marine applications under the trade names of ‘Dry-Fast’ or ‘Dri-Fast’. These types of foams are typically available with a density of approximately 1.8-1.9 lb/ff3 and 50 ILD for boat seat cushions and 33 ILD for boat back cushions. Because of the relatively large cell structure of this foam, water passes through the foam without being retained.

Furthermore, a closed cell foam is foam that could be used in accordance with the teachings of the present invention. The densities and deflections (ILD) are similar to the dry-fast, open cell foams as described herein. With the closed cell foams, water does not pass through the foam but instead is prevented from entering the cells of the foam because the cells are closed. Consequently, the closed cell structure this type of foam also prevents any significant amount of water from being retained by the foam.

Either of these waterproof/water resistant foams can be used to make foam particles which are suitable for the stuffing of the soft chairs or other soft furniture.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed. Hence, it is to be understood, however, that the invention is not limited to the specific features shown and described, since the means herein disclosed comprise preferred forms of putting the invention into effect. The invention is, therefore, claimed in any of its forms or modifications within the proper scope of the appended claims. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention.

1. A fill for soft furniture, comprising;
a first type of particle for filling said soft furniture;
a second type of particle for filling said soft furniture;
wherein said soft furniture is frameless or semi-frameless and said first type of particle is mixed with said second type of particle.

2. A fill for soft furniture as in claim 1, wherein said first type of particle includes a bead particle.

3. A fill for soft furniture as in claim 1, wherein said second type of particle includes a foam particle.

4. A fill for soft furniture as in claim 1, wherein said first type of particle includes a bead particle and said second type of particle includes a foam particle.

5. A fill for soft furniture as in claim 1, wherein said first type of particle includes a virgin bead particle.

6. A fill for soft furniture as in claim 1, wherein said first type of particle includes a regrind bead particle.

7. A fill for soft furniture as in claim 1, wherein said first type of particle includes a polystyrene bead particle.

8. A fill for soft furniture as in claim 1, wherein said first type of particle includes a double pass bead and a single pass bead.

9. A fill for soft furniture as in claim 8, wherein the number of double pass beads is approximately one half the number of single pass beads.

10. A fill for soft furniture as in claim 4, wherein the number of the bead particles is approximately equal to the number of foam particles.

11. A method for forming a fill for soft furniture, comprising the steps of;
forming a first type of particle for filling said soft furniture;
forming a second type of particle for filling said soft furniture; and
mixing said first type of particle with said second type of particle.

12. A method for forming a fill for soft furniture as in claim 11, wherein the step of forming said first type of particle includes forming a bead particle.

13. A method for forming a fill for soft furniture as in claim 11, wherein the step of forming said second type of particle includes forming a foam particle.

14. A method for forming a fill for soft furniture as in claim 11, wherein the step of forming said first type of particle includes forming a bead particle and the step of forming said second type of particle includes forming a foam particle.

15. A method for forming a fill for soft furniture as in claim 11, wherein the step of forming said first type of particle includes forming a virgin bead particle.

16. A method for forming a fill for soft furniture as in claim 11, wherein the step of forming said first type of particle includes forming a regrind bead particle.

17. A method for forming a fill for soft furniture as in claim 11, wherein the step of forming said first type of particle includes forming a polystyrene bead particle.

18. A method for forming a fill for soft furniture as in claim 11, wherein the step of forming said first type of particle includes forming a double pass bead and a single pass bead.

19. A method for forming a fill for soft furniture as in claim 18, wherein the number of double pass beads is approximately one half the number of single pass beads.

20. A method for forming a fill for soft furniture as in claim 14, wherein the number of the bead particles is approximately equal to the number of foam particles.
